(19) United States
(12) Patent Application Publication
(10) Pub. No.: US 2026/0233724 A1
(43) Pub. Date: Aug. 13, 2026

(54) METHOD FOR CONTROLLING A WHEEL-SPECIFIC ELECTROHYDRAULIC BRAKE ACTUATOR; WHEEL-SPECIFIC ELECTROHYDRAULIC BRAKE ACTUATOR, AND ELECTRONICALLY SLIP-CONTROLLABLE POWER BRAKING SYSTEM WITH WHEEL-SPECIFIC ELECTROHYDRAULIC BRAKE ACTUATOR

(71) Applicant: Robert Bosch GmbH, Stuttgart (DE)

(72) Inventors: Andreas Weh, Sulzberg (DE); Bertram Foitzik, Ilsfeld (DE); Michael Wilcox, Charleston, SC (US); Otmar Bussmann, Abstatt (DE); Urs Bauer, Sachsenheim (DE)

(21) Appl. No.: 19/152,147

(22) PCT Filed: Mar. 20, 2024
(86) PCT No.: PCT/EP2024/057391

§ 371 Date: Jul. 30, 2025

(30) Foreign Application Priority Data
Apr. 27, 2023 (DE) 10 2023 203 907.9

(51) Int. Cl. B60T 13/74; B60T 13/14; B60T 13/68

(52) U.S. Cl. CPC B60T 13/745; B60T 13/148; B60T 13/686; B60T 2220/04; B60T 2270/10

(57) ABSTRACT

A method for controlling a wheel-specific electrohydraulic brake actuator, a wheel-specific electromechanical brake actuator, and an electronically slip-controllable power braking system with a wheel-specific electrohydraulic brake actuator. Brake actuators are provided with a housing block. A motor is arranged thereon for actuating a brake pressure generator, a pressure medium reservoir, a pressure channel from the brake pressure generator to a wheel connection for a wheel brake, and an electronic control unit. A method provides for controlling a brake actuator, in which the driving of the brake pressure generator is controlled by the electronic control unit to regulate the pressure at the wheel connection and the pressure channel can be controlled using an electrically actuatable isolating valve which is controlled by the electronic control unit at least for pressure reduction in such a way that it assumes an open position.

### BACKGROUND INFORMATION

Power braking systems with electronic slip control are included in the related art. They differ from conventional muscle-powered braking systems in that the generation of brake pressure can be carried out independently of the driver. Their general task is to prevent wheel slip, which occurs during driving of a motor vehicle, on one or more wheels by regulating the brake pressure in a wheel-specific manner and thus counteracting unstable driving conditions of the motor vehicle.

Conventional vehicle braking systems with hydraulic wheel brakes have a hydraulic unit which generates brake pressure centrally and regulates it in a wheel-specific manner. This hydraulic unit comprises a housing block, to which the individual wheel brakes are connected, for example via brake lines. To generate and regulate the brake pressure, a brake pressure generator drivable by an electrically controllable motor as well as electrically controllable valves are arranged on the housing block. The motor and the valves are electrically controlled by an electronic control unit depending on a present braking requirement or braking request. This electronic control unit is preferably mounted on the housing block.

The braking requirement or braking request can be specified by a driver by actuating a master brake cylinder and/or by vehicle electronics for detecting unstable and/or accident-prone driving conditions of the vehicle.

In hydraulic units of modern vehicle braking systems, the master brake cylinder is integrated into the housing block of the hydraulic unit.

Such a vehicle braking system is described in Germany Patent Application No. DE 10 2021 207 848A1, for example.

Apart from hydraulic vehicle braking systems with central brake pressure supply, decentralized vehicle braking systems with wheel-specific brake actuators are described in the related art.

A vehicle braking system with brake actuators in the form of electromechanically actuatable wheel brakes is described, for example, in Germany Patent Application No. DE 10 2019 219 002A1. For generating braking forces, the brake actuators are individually electrically controlled or regulated by a control unit depending on the existing braking requirement. Such vehicle braking systems are inter alia characterized by less effort in the final vehicle assembly since, for example, a central hydraulic unit for pressure generation and regulation can be dispensed with and because there is no need for complex bleeding and initial filling of the vehicle braking system with hydraulic pressure medium. Naturally, electromechanical wheel brakes do not have any problems with regard to possible leaks or pressure medium contaminated by gas.

However, for the same braking performance as hydraulically actuated wheel brakes, electromechanical wheel brakes are more expensive, bulkier and heavier. The latter inter alia influences the chassis tuning of a motor vehicle.

In addition to hydraulically or electromechanically actuated wheel brakes, electrohydraulically actuated wheel brakes are also described in the related art. In electrohydraulic wheel brakes, the braking force provided by a drive motor is hydraulically transmitted to friction-force-generating means of a wheel brake.

### SUMMARY

The present invention provides a wheel-specific electrohydraulic brake actuator. According to an example embodiment of the present invention, such a brake actuator preferably comprises a housing block which is attached to the body and has a motor arranged thereon for actuating a pressure generator, a pressure medium reservoir for storing pressure medium, and an electronic control unit. Channels carrying pressure medium are formed on the housing block, in particular a controllable pressure channel, which connects a working chamber of the pressure generator to a wheel connection on the housing block.

Multiple such brake actuators together form the vehicle braking system of a modern motor vehicle and, due to their redundancy, ensure the braking function in the event of failure of individual brake actuators. Brake actuators according to the present invention require few pressure-medium-controlling components and are therefore compact and lightweight. Furthermore, brake actuators according to the present invention do not contribute to an increase in the sprung mass of a vehicle wheel, since they are to be attached to the body of a vehicle.

In addition, the brake actuators of the present invention are suitable for integration into so-called corner modules. The steering system, brake and/or drive of a vehicle are each designed in such a modular way that the individual modules for each corner or each wheel of a vehicle are designed the same or very similarly and can be integrated into a vehicle with just a few standardized interfaces.

According to the present invention, at each wheel, the brake pressure can be adjusted in a wheel-specific manner by means of a brake actuator according to the present invention with the aid of a pressure sensor, without hydraulic coupling effects occurring between the brake actuators on the individual wheels, as is the case with conventional vehicle braking systems with central pressure supply.

Further advantages or advantageous developments of the present invention can be found in the disclosure herein.

### BRIEF DESCRIPTION OF THE DRAWINGS

Exemplary embodiments of the present invention are shown in the figures and explained in more detail in the following description.

FIG. 1 shows a first exemplary embodiment of a brake actuator according to the present invention on the basis of a first hydraulic circuit diagram.

FIG. 2 shows a second exemplary embodiment of the present invention on the basis of a second hydraulic circuit diagram.

FIG. 3 shows a third exemplary embodiment of the present invention on the basis of a third hydraulic circuit diagram.

FIG. 4 shows, in a schematically greatly simplified manner, a motor vehicle with a vehicle braking system in a plan view, according to an example embodiment of the present invention.

Corresponding components are provided with the same reference signs in the individual figures.

### DETAILED DESCRIPTION OF EXAMPLE EMBODIMENTS

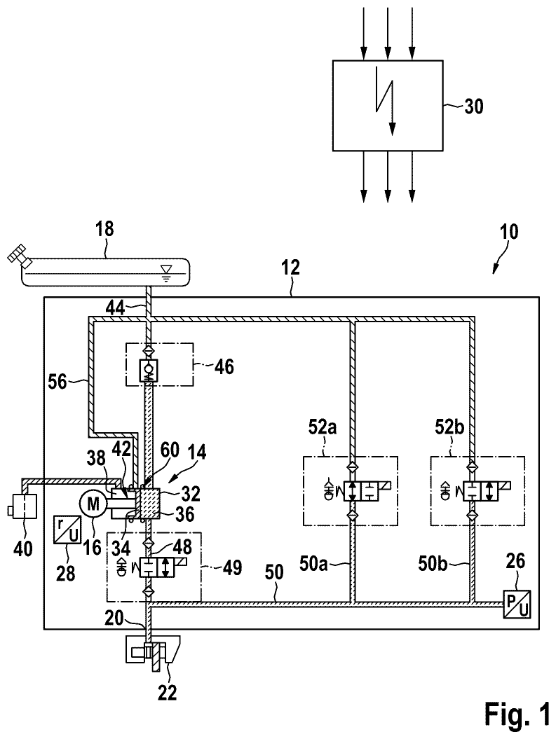

As mentioned, FIG. 1 shows a first exemplary embodiment of a wheel-specific electrohydraulic brake actuator (10). The main components of this brake actuator (10) are arranged or mounted on a housing block (12), which is schematically indicated in the figure by means of an outline. These components are a brake pressure generator (14), an electrically controllable motor (16) for driving this brake pressure generator (14), a pressure medium reservoir (18) for supplying pressure medium to a pressure medium circuit, and a wheel connection (20) formed on the housing block (12) for hydraulic contact of the brake actuator (10) with one of the wheel brakes (22) of a vehicle braking system, e.g., via a brake line or a brake hose. Furthermore, the brake actuator (10) comprises a pressure sensor (26) for detecting the brake pressure at the wheel connection (20) or at the connected wheel brake (22), a rotation angle sensor (28) for detecting a rotation angle of a drive shaft of the motor (16), and an electronic control unit (30) for detecting and evaluating an incoming braking request, incoming signals from the mentioned sensors and for needs-based electrical control of the motor (16), among other things.

The brake pressure generator (14) is formed by a unit composed of a cylinder (32) and a piston (34) slidably accommodated therein, in short a piston-cylinder unit. The piston (34) divides an interior of the cylinder (32) into a working chamber (36) that can be filled with pressure medium and a drive chamber (38) that is close to the motor (16) and free of pressure medium. The interior of this drive chamber (38) is ventilated to the environment via a pressure compensation element (40) and accommodates a gear arrangement, in the exemplary embodiment a spindle drive or a ball screw drive (42). This gear arrangement converts a rotational movement of a drive shaft of the motor (16) into a translational movement of the piston (34).

The motor (16) can drive the piston (34) forward in a first direction of rotation of the drive shaft, i.e., in a pressure build-up direction, or backward in the opposite direction of rotation in a pressure reduction direction. When driven in the pressure build-up direction, the piston (34) displaces pressure medium from the working chamber (36) in the direction of the wheel connection (20) and thus builds up brake pressure in the wheel brake (22) connected thereto, whereas, in the pressure reduction direction, the volume of the working chamber (36) increases gradually so that pressure medium flows from the connected wheel brake (22) into the working chamber (36) and the pressure in the wheel brake (22) is reduced. A distance traveled by the piston (34) is proportional to the rotation angle of the drive shaft of the motor (16) detected by the rotation angle sensor (28). This rotation angle is used by the electronic control unit (30) to evaluate the distance traveled by the piston (34), the direction of travel, and the volume of pressure medium that has been displaced due to the piston movement.

Various pressure medium channels are provided on the housing block (12) of the brake actuator (10) and hydraulically connect the mentioned components to one another to form the pressure medium circuit. A first pressure medium channel leads from the pressure medium reservoir (18) to the working chamber (36) of the brake pressure generator (14) and forms a supply channel (44). In the exemplary embodiment according to FIG. 1, a so-called plunger charging valve (46) is arranged in this supply channel (44). This valve is a hydraulically actuatable check valve, which is permeable in one direction from the pressure medium reservoir (18) to the brake pressure generator (14) and blocks the opposite direction. The plunger charging valve (46) prevents pressure medium displaced from the working chamber (36) of the brake pressure generator (14) from flowing into the pressure medium reservoir (18) and also improves the bleedability of the brake actuator (10) during assembly.

Furthermore, a second pressure medium channel is provided on the housing block (12) of the brake actuator (10), which pressure medium channel leads from the working chamber (36) of the brake pressure generator (14) to the wheel connection (20) of the housing block (12) and thus ultimately to a wheel brake (22) connectable thereto. The second pressure medium channel forms a pressure channel (48), the flow through which is controllable by means of an isolating valve (49). This isolating valve (49) is a 2/2-way switching valve, which can be switched from a normally closed default position to an open position by electrical control.

A third pressure medium channel is called the relief channel (50). The latter branches off from the pressure channel (48) in the region downstream of the isolating valve (49) and flows into the supply channel (44) in a region between the plunger charging valve (46) and the pressure medium reservoir (18). The relief channel (50) thus establishes a hydraulic connection between the wheel brake (22) and the pressure medium reservoir (18), which hydraulic connection is controllable by a first relief valve (52a) in a first channel branch (50a) and/or by a second relief valve (52b) in a second channel branch (50b) running parallel to the first channel branch (50a). The first relief valve (52a) is a normally open 2/2-way switching valve, whereas the second relief valve (52b) is formed by a normally closed 2/2-way switching valve. The switching valves differ in the size of their passage cross-sections, the passage cross-section of the first relief valve (52a) being larger than that of the second relief valve (52b). The relief valves (52a, b) are switched by electrical control by the electronic control unit (30). Both relief valves (52a, b) assume their blocking position due to corresponding control by the electronic control unit (30) when brake pressure is built up in the wheel brake (22) by the brake pressure generator (14), i.e., when the piston (34) is driven forward in the pressure build-up direction.

If pressure in the connected wheel brake (22) is to be reduced with high dynamics, which cannot be achieved solely by moving the brake pressure generator (14) in the pressure reduction direction, at least the first relief valve (52a) is controlled by the electronic control unit (30) in such a way that it assumes its open position. The use of a normally open first relief valve (52a) is provided because this makes it possible to reduce pressure even in the event of a fault, i.e., in the event of a power supply failure, i.e., when neither the relief valves (52a, b) nor the brake pressure generator (14) can be electrically operated.

In contrast to the first relief valve (52a), the second relief valve (52b) is designed as a normally closed directional valve. It is switched to its open position by the electronic control unit (30) when higher flow rates are required to reduce pressure than the normally open first relief valve (52a) can provide. The advantage of designing the second relief valve (52b) as normally closed is that it is only needed in rare cases and therefore requires less energy than the use of a normally open valve at this point.

Pressure medium can heat up during a braking process and therefore take up a larger volume at the end than at the beginning of this braking process. If there were no pressure medium connection between the wheel connection (20) and the pressure medium reservoir (18), a residual brake pressure could therefore develop at the wheel connection (20), even though the piston (34) of the brake pressure generator (14) has been actuated in the pressure reduction direction and has already reached its inner stop or the default position. By using a first relief valve (52a), which is designed as a normally open valve, the formation of such residual brake pressure is prevented.

FIG. 1 finally discloses a lubricant channel (56), via which the pressure medium reservoir (18) is connected to a receiving groove in the cylinder (32), in which receiving groove a sealing arrangement (60) sealing the piston (34) in the cylinder (32) is arranged. Via this lubricant channel (56), hydraulic pressure medium reaches the sealing arrangement (60), lubricates it and thus prevents possible seal wear. Over its entire adjustment path, the piston (34) is in mechanical contact with this sealing arrangement (60) via a piston skirt so that no pressure medium from the lubricant channel (56) can enter the drive chamber (38) or the working chamber (36) of the brake pressure generator (14). If the sealing arrangement (60) is undamaged, pressure medium does not flow in the lubricant channel (56).

In normal operation, the brake force actuator (10) explained works as follows:

A motor vehicle equipped with the wheel-specific electrohydraulic brake actuator (10) is equipped with a device for specifying a braking request or braking event. This device can be a conventionally actuatable brake pedal, a brake lever, or a sensor device, the actuation of which by a driver generates an actuation signal proportional to the braking event or the braking request. Alternatively, the actuation signal can be provided by an electronic system if the electronic system has detected a critical driving condition of the vehicle or an accident-prone driving situation. From the incoming braking request signal, the electronic control unit (30) ascertains control signals to the motor (16) of the brake pressure generator (14) and to the first relief valve (52a), which, as a result, switches from its open default position to a blocking position. The motor (16) drives the piston (34) of the brake pressure generator (14) in the pressure build-up direction so that pressure medium is displaced from the working chamber (36) in the direction of the wheel connection (20) or wheel brake (22) until brake pressure corresponding to the braking request has developed there. The latter is monitored by the electronic control unit (30) by means of the pressure sensor (26).

When the desired brake pressure is reached in the wheel brake (22), the forward movement of the piston (34) is terminated while the current supply to the normally open first relief valve (52a) is maintained. Consequently, the relief channel (50) remains blocked and the brake pressure currently prevailing in the wheel brake (22) is maintained.

To reduce the brake pressure, the motor (16) of the brake pressure generator (14) is driven in the pressure reduction direction so that the piston (34) moves backward in the direction of its original default position. The volume of the working chamber (36) of the brake pressure generator (14) gradually increases, as a result of which pressure medium flows out of the wheel brake (22) and into the working chamber (36) until the desired, now lower, pressure level is finally established in the wheel brake (22). According to the present invention, the isolating valve (49) in the pressure channel (48) remains in the open position even during a brake pressure reduction.

If the brake pressure in the wheel brake (22) is to be reduced to zero, for example if there is no longer any braking request, the piston (34) of the brake pressure generator (14) is moved back to its default or initial position. The volume of the working chamber (36) has its maximum volume in this initial position of the piston (34).

As mentioned above, due to an increase in the temperature of the pressure medium during a braking process, the pressure medium volume may have increased so that the pressure in the wheel brake (22) has dropped to a residual pressure greater than zero when the piston (34) of the brake pressure generator (14) has reached its default position.

In this case, the remaining residual brake pressure is reduced via the normally open first relief valve (52a) or, if a higher flow rate is required for higher dynamics of the pressure reduction than the first relief valve (52a) can provide, by additional electrical control of the normally closed second relief valve (52b). That opens the second channel branch (50b) of the relief channel (50) and thus establishes a further hydraulic connection between the wheel brake (22) and the pressure medium reservoir (18). Since atmospheric pressure prevails in the pressure medium reservoir (18), any residual pressure in the wheel brake (22) is then reduced very quickly.

The dynamics or speed of pressure reduction that can be carried out by the brake pressure generator (14) is limited due to the mechanical conditions of its drive. If, due to the present braking situation, it is necessary to reduce the pressure more quickly, i.e., with higher dynamics, for example during a braking process with parallel slip control, this is done by interrupting the electrical control of the first relief valve (52a) in the first channel branch (50a), which first relief valve has a larger passage cross-section. Driven by a mechanical return device, this first relief valve (52a) then returns to its default position and releases the pressure medium connection between the wheel brake (22) and the pressure medium reservoir (18). The second relief valve (52b) may remain closed as required or may additionally be opened by electrical control.

A pressure reduction speed limit value, from which the brake pressure is no longer reduced solely by the brake pressure generator (14) but with the aid of the relief channel (50), was ascertained empirically and is electronically stored in the electronic control unit (30) of the brake actuator (10).

The pressure medium flowing out of the wheel brake (22) into the pressure medium reservoir (18) during a dynamic brake pressure reduction is no longer available to the brake pressure generator (14) for a subsequent brake pressure build-up and must therefore be replenished at the end of a braking process. For this purpose, the connection between the brake pressure generator (14) and the pressure medium reservoir (18) via the normally open first relief valve (52a) is blocked by electrical actuation of the isolating valve (49) in the pressure channel (48) while the piston (34) of the brake pressure generator (14) is driven back toward its default position by the motor (16) in parallel thereto. The increasing volume of the working chamber (36) causes a negative pressure in the supply channel (44), as a result of which the plunger charging valve (46) opens and pressure medium thus flows from the pressure medium reservoir (18) into the working chamber (36). As soon as the piston (34) of the brake pressure generator (14) has returned to its default or initial position, the original initial conditions are restored and the brake force actuator (10) is available for subsequent brake pressure generation.

The explained regulation of the brake pressure must be temporarily suspended if the piston (34) has moved forward in the cylinder (32) due to pressure medium that has been released into the pressure medium reservoir (18) as part of a brake slip control, to such an extent that it has approached a specified outer end point or reversal point and the residual volume of pressure medium remaining in the working chamber (36) is no longer sufficient to carry out emergency braking with maximum brake pressure. The position of the piston (34) within the cylinder (32) of the brake pressure generator (14) is known as a result of the electronic control unit (30) evaluating the rotation angle signal of the motor (16) supplied by the rotation angle sensor (28). In this case, too, the isolating valve (49) in the pressure channel (48) closes and the piston (34) of the brake pressure generator (14) is returned to its default position. In doing so, it draws in new pressure medium from the pressure medium reservoir (18) via the plunger charging valve (46), as described above. When the default position is reached, the isolating valve (49) opens and the interrupted brake pressure regulation is continued.

Furthermore, the isolating valve (49) can be used to prevent thermal overload of the motor (16) for driving the brake pressure generator (14). If, during a braking process, no pressure change occurs at the wheel connection (20) over a specifiable time interval stored in the electronic control unit (30), the electronic control unit (30) controls this isolating valve (49) in such a way that it assumes the blocking position. Together with the relief channel (50), which is also blocked when brake pressure is applied to the wheel brake (22), the brake pressure is thereby trapped in the section of the pressure medium circuit coupled to the wheel brake (22), so that the brake pressure generator (14) is no longer required to maintain it. Consequently, the current supply to the motor (16) can at least be reduced or, where appropriate, completely stopped.

As soon as the vehicle braking system requests a pressure change at the wheel brake (22), the isolating valve (49) opens and the brake pressure generator (14) is supplied with power in order to raise or lower the prevailing brake pressure level.

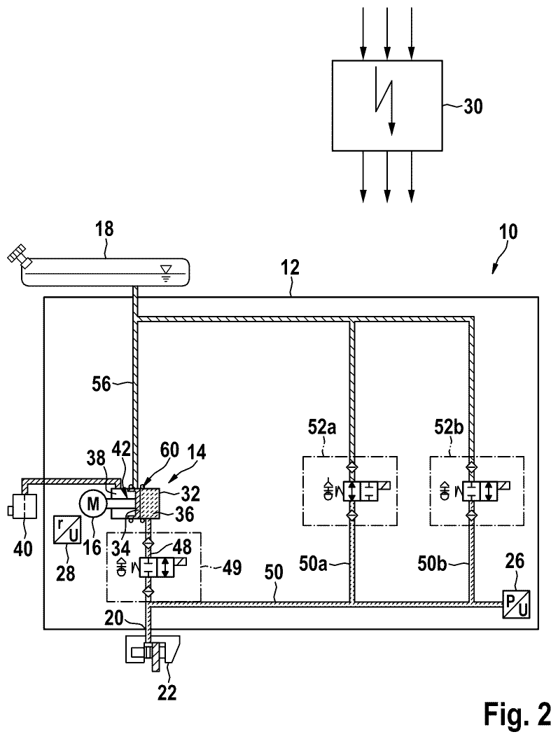

FIG. 2 shows a second exemplary embodiment of a wheel-specific electrohydraulic brake actuator (10) according to the present invention. The latter comprises, apart from the missing supply channel and the missing plunger charging valve, the same components as the brake actuator (10) described in connection with FIG. 1. In the exemplary embodiment according to FIG. 2, the function of the supply channel and of the plunger charging valve is taken over by the electrically controllable first channel branch (50a) and the first relief valve (52a), which reduces the mechanical effort for machining the housing block (12) and makes a more compact design of the brake actuator (10) possible. Pressure medium, which must be replenished in the working chamber (36) of the brake pressure generator (14) at the end of a braking process with parallel brake slip control due to the brake pressure reduction processes, in this second exemplary embodiment flows from the pressure medium reservoir (18) back to the brake pressure generator (14) via the first channel branch (50a) released by the first relief valve (52a). However, for this to happen, the isolating valve (49) in the pressure channel (48) must remain in its open position.

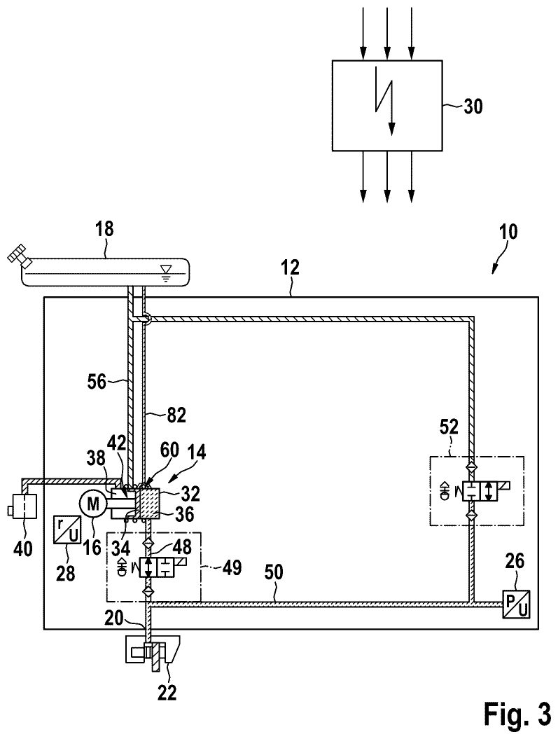

In a manner comparable to exemplary embodiment 2, the third exemplary embodiment of the present invention according to FIG. 3 also does not require a supply channel or a plunger charging valve and, in addition, eliminates the first channel branch and the first relief valve of the relief channel (50). Consequently, this brake actuator (10) comprises a minimum of components and is therefore simple and cost-effective as well as extremely compact.

For this purpose, in addition to the described exemplary embodiments, the brake actuator (10) comprises a compensation channel (82), which connects the pressure medium reservoir (18) to the brake pressure generator (14) and, in addition, is designed to be controllable. The compensation channel (82) is controlled by the piston (34) in that the piston acts as a slide, which releases the pressure medium connection as soon as it has assumed the default or initial position, and interrupts this pressure medium connection via its piston skirt as soon as it has been actuated from the default position in the pressure build-up direction.

The reason for the need for a compensation channel (82) is that it would not be possible with the second relief valve (52b), due to its design as a normally closed valve, to provide a pressure medium connection between the wheel connection (22) and the pressure medium reservoir (18) in the event of a power supply failure in order to reduce any brake pressure that may be present in the wheel brake (22). However, such a brake pressure reduction via the compensation channel (82) in the event of a fault requires a non-self-locking drive for the brake pressure generator (14). In the event of a power failure, the piston (34), driven by the pressure in the working chamber (36), is moved back to its initial or default position by a non-self-locking drive and the pressure medium connection is opened via the mentioned compensation channel (82). Furthermore, it is necessary to use a normally open isolating valve (49) in the pressure channel (48) to hydraulically connect the wheel brake (22).

Alternatively, in the exemplary embodiment according to FIG. 3, a normally closed isolating valve (49) could be used in the pressure channel (48) as before, if instead the relief valve (52) in the relief channel (50) were designed to be normally open. Such a relief valve (52) would maintain the pressure medium connection between the wheel connection (50) and the pressure medium reservoir (18) for pressure reduction in the event of a power supply failure. However, the disadvantage of this alternative is that pressure medium in the working chamber (36) must be replenished via the isolating valve (49) after slip-controlled braking processes, but this isolating valve (49) remains closed in the event of a fault, and pressure reduction in the working chamber (36) of the brake pressure generator (14) is thus excluded.

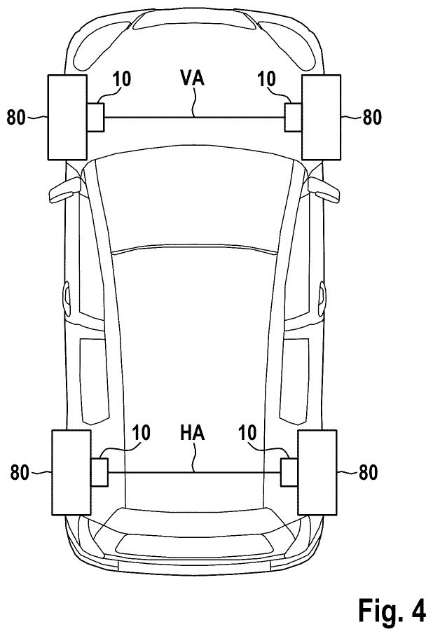

Finally, FIG. 4 shows a schematically greatly simplified plan view of a vehicle with a vehicle braking system. This vehicle has a total of 4 wheels (80) distributed on two vehicle axles (FA, HA) and has an assigned brake actuator (10) for each wheel (80), i.e., a total of 4 brake actuators (10). The existing brake actuators (10) can be of the same design, but it is also possible that only the brake actuators of one axle have the same design and the vehicle is thus equipped with different brake force actuators per axle. Preferably, at least the front axle (VA) of the motor vehicle is equipped with wheel-specific electrohydraulic brake actuators (10) according to the present invention. Instead of brake actuators (10) according to the present invention, electromechanical brake actuators may, for example, be used on the wheel brakes of the rear axle (HA). Vehicle braking systems with different braking actuators are called hybrid braking systems.

Of course, changes or additions beyond these explanations are possible without departing from the scope of the present invention.

For example, it would be possible that the explained brake actuators are each additionally equipped with at least one low-pressure accumulator, which temporarily stores the pressure medium released from the wheel brake (22) during a brake pressure reduction, in order to make it available to the pressure generator (14), for example when the pressure generator is actuated in the pressure reduction direction.

1-6. (canceled)

7. A method for control a wheel-specific electrohydraulic brake actuator of a motor vehicle having wheel brakes, the wheel-specific electrodrualic brake actuator including:
a housing block having a wheel connection for hydraulic contact with one of the wheel brakes of the motor vehicle,
a brake pressure generator arranged on the housing block, actuatable using an electrically controllable drive and having a cylinder, a piston guided in the cylinder and drivable to a translational movement, and a working chamber enclosed by the cylinder and the piston, wherein a volume of the working chamber decreases when the piston is driven forward in a pressure build-up direction and increases when the piston is driven backward in a pressure reduction direction opposite to the pressure build-up direction,
a pressure channel on the housing block, which pressure channel connects the working chamber of the brake pressure generator to the wheel connection, and
an electronic control unit,
the method comprising the following steps:
regulating by the electronic control unit a brake pressure at the wheel connection via electrical control of the motor, which is adapted to a braking request; and
controlling the pressure channel using an electrically actuatable isolating valve which is controlled by the electronic control unit, at least when the brake pressure at the wheel connection is reduced, in such a way that isolating valve assumes an open position.

8. The method according to claim 7, wherein the isolating valve is electrically control by the electronic control unit in such a way that the isolating value assumes a blocking position as soon as a time interval stored in the electronic control unit is reached or exceeded during a braking process, during which time interval no pressure change has taken place at the wheel connection.

9. The method according to claim 7, wherein a supply channel which connects the brake pressure generator to a pressure medium reservoir, is provided, and wherein the isolating valve is electrically controlled by the electronic control unit in such a way that the isolating valve assumes a blocking position when, after a braking process with parallel brake slip control, the brake pressure at the wheel connection has been reduced and the piston of the brake pressure generator is moved further in the pressure reduction direction.

10. The method according to claim 7, wherein at least one relief channel is provided which can be controlled by an electrically controllable relief valve and connects the wheel connection to the pressure medium reservoir, wherein the relief valve is electrically controlled by the electronic control unit in such a way that the relief valve assumes a blocking position when the pressure at the wheel connection is maintained or increased by the brake pressure generator, and wherein the relief valve is electrically controlled by the electronic control unit in such a way that the relief valve assumes an open position when the pressure at the wheel connection is to be reduced as part of a braking process or when the piston of the brake pressure generator is moved further in the pressure reduction direction as part of a braking process with parallel brake slip control after the brake pressure has been reduced at the wheel connection.

11. A wheel-specific electrohydraulic brake actuator for a motor vehicle having wheel brakes, the wheel-specific electrohydraulic brake actuator comprising:
a housing block having a wheel connection for hydraulic contact with one of the wheel brakes of the motor vehicle;
a brake pressure generator arranged on the housing block, actuatable using an electrically controllable drive and having a cylinder, a piston guided in the cylinder and drivable to a translational movement, and a working chamber enclosed by the cylinder and the piston, wherein a volume of the working chamber decreases when the piston is driven forward in a pressure build-up direction and increases when the piston is driven backward in a pressure reduction direction opposite to the pressure build-up direction;
a pressure channel on the housing block, which pressure channel connects the working chamber of the brake pressure generator to the wheel connection; and
an electronic control unit, wherein the electronic control unit is configured to regulate the brake pressure at the wheel connection via electrical control of the motor, which is adapted to a braking request, and wherein the pressure channel is controllable using an electrically actuatable isolating valve which is controlled by the electronic control unit, at least when the brake pressure at the wheel connection is reduced, in such a way that the actuatable isolating valve assumes an open position.

12. An electronically slip-controllable power braking system for a vehicle with wheels brakes, the system comprising:
a wheel-specific electrohydraulic brake actuator on each respective wheel of at least one axle of the vehicle, each wheel-specific electrohydraulic brake actuator including:
a housing block having a wheel connection for hydraulic contact with a wheel brake of the respective wheel,
a brake pressure generator arranged on the housing block, actuatable using an electrically controllable drive and having a cylinder, a piston guided in the cylinder and drivable to a translational movement, and a working chamber enclosed by the cylinder and the piston, wherein a volume of the working chamber decreases when the piston is driven forward in a pressure build-up direction and increases when the piston is driven backward in a pressure reduction direction opposite to the pressure build-up direction,
a pressure channel on the housing block, which pressure channel connects the working chamber of the brake pressure generator to the wheel connection, and
an electronic control unit, wherein the electronic control unit is configured to regulate the brake pressure at the wheel connection via electrical control of the motor, which is adapted to a braking request, and wherein the pressure channel is controllable using an electrically actuatable isolating valve which is controlled by the electronic control unit, at least when the brake pressure at the wheel connection is reduced, in such a way that the actuatable isolating valve assumes an open position.
